(19) United States
(12) Patent Application Publication
(10) Pub. No.: US 2026/0054371 A1
(43) Pub. Date: Feb. 26, 2026

(54) ADJUSTABLE PASSIVE EXOSKELETON

(71) Applicant: Interact Medikal Teknolojileri Anonim Sirketi, Pendik/Istanbul (TR)

(72) Inventors: Volkan Patoglu, Pendik/Istanbul (TR); Mehmet Alper Ergin, Pendik/Istanbul (TR); Gokay Coruhlu, Pendik/Istanbul (TR); Mustafa Yalcin, Pendik/Istanbul (TR); Orhan Esad Daybelge, Pendik/Istanbul (TR)

(21) Appl. No.: 19/103,758

(22) PCT Filed: Aug. 16, 2022
(86) PCT No.: PCT/TR2022/050862

§ 371 Date: Feb. 13, 2025

(51) Int. Cl. B25J 9/00

(52) U.S. Cl. CPC B25J 9/0006

(57) ABSTRACT

The present invention relates to an exoskeleton (100) configured to be worn by a user in order to support and transfer a load carried by the user comprising a hip module (300) which is connected to two leg modules (400) each connected to two foot modules (500) respectively, wherein said exoskeleton (100) is adapted to be maintained on the body of the user and follow the user's movements and wherein said exoskeleton (100) is configured in such a way as to transfer to the load carried by the user from the hip module (300) down to the ground via the leg modules (400) and the foot modules (500) when the exoskeleton (100) is in use. In one embodiment, the exoskeleton further comprises a back module (200).

### TECHNICAL FIELD OF THE PRESENT INVENTION

The present invention relates to an exoskeleton to assist a wearer in carrying loads. More particularly, the present invention relates to a passive exoskeleton having improved ergonomics and efficient load distribution while transferring the load normally carried by the wearer down to the ground and configured to be adjustable to the wearer's specific anatomy to support a wearer in carrying loads.

### BACKGROUND OF THE PRESENT INVENTION

Heavy load carriage is associated with an increased risk of musculoskeletal injuries and decreases in performance during military tasks; however, it is essential for operational effectiveness. Exoskeletons have the potential to reduce the musculoskeletal load at comparable work demands, such as during heavy load carriage tasks, which could reduce injury risks. An exoskeleton can be defined as a wearable, external mechanical structure that enhances the performance of a person. Exoskeletons can be classified as ‘active’ or ‘passive’. An active exoskeleton comprises one or more actuators that augments the human's power and helps in actuating the human joints. These actuators may be electric motors, hydraulic actuators, pneumatic muscles, or other types. A strictly passive exoskeleton does not use any type of actuator, but rather uses materials, springs, or dampers with the ability to store energy harvested by human motion and to use this as required, and/or to implement a supporting structure to transfer load to the ground to support a posture or a motion. Exoskeletons may also be defined by the supported body part(s): providing power or support to the lower limbs (lower body exoskeletons), to the upper extremities (upper body exoskeletons), and to both upper and lower extremities (full body exoskeletons). Among these, passive exoskeletons for industrial applications have been shown to reduce perceived effort, erector spinae muscle activity, and lumbar compression forces, as well as low back discomfort, during sustained forward bending. One of the most important challenges in exoskeleton design is ensuring close fit for different size users while simultaneously accommodating the natural movements of the user (Gruevski, Kristina M., et al. “A Pilot Investigation of the Influence of a Passive Military Exoskeleton on the Performance of Lab-Simulated Operational Tasks.” IISE transactions on occupational ergonomics and human factors 8.4 (2020): 195-203; De Looze, Michiel P., et al. “Exoskeletons for industrial application and their potential effects on physical workload.” Ergonomics 59.5 (2016): 671-681).

Therefore, there is a need in the art for an exoskeleton that is able to ergonomically allow the movements of the user and effectively transfer the load to the ground. In addition, the exoskeleton has to be light and easily wearable, operate silently, and be able to function in difficult conditions, such as extreme temperatures, dust, or mud.

Among others, a prior art publication in the technical field of the present invention may be referred to as U.S. Pat. No. 10,234,242, which discloses a wearable supporting structure for supporting ballistic protections and/or military equipment. The supporting structure comprises a band suitable to be wrapped around the waist or hips of the wearer, a dorsal upright having a lower end coupled to the band and extending upwards from the band, a vest for supporting ballistic protections and/or other military equipment coupled to the dorsal upright and comprising two shoulder straps, and a unit connecting the shoulder straps to the band. The connecting unit comprises a motor in order to adjust the position of the load between the shoulders and the hips of the wearer. However, the presence of the motor leads to higher maintenance requirements.

Another reference can be given as WO 2015/174890 which discloses a load-bearing exoskeleton comprising a frame with elements for fastening to the torso, and two pairs of hip and ankle levers. The frame consists of a shoulder unit in the form of a combination of plates, a lumbar unit consisting of a belt-like yoke which is curved in accordance with the shape of the lumbar area of the human body, and a support platform secured to the top central point of the yoke. The hip levers are connected to the frame by annular cardan joints in a way to allow the wearer the ability to turn the upper body to the right and left and the support platforms are detachably connected to an ankle fork. However, this exoskeleton uses a swivel joint mechanism with a fixed axis of rotation at the knee section, which does not accurately mimic the movement of the knee and can cause ergonomic problems.

While the anatomical knee joint is assumed to be a hinge joint for the sake of design simplicity, the axis of rotation of the human knee joint translates during flexion/extension movements of the knee as a result of rolling and sliding of the femur on the tibial plateau. Bracing a single fixed axis orthotic joint on the human knee joint with translating axis of rotation creates a relative sliding motion between the orthosis and the limb, which causes discomfort to the wearer. Therefore, polycentric linkage mechanisms are preferred instead of fixed-axis hinge joints to ensure axis alignment between the human knee and the orthosis. Among polycentric linkages, the four-bar linkage mechanism, which is a planar mechanism with four links pivoted to one another, is the simplest movable closed-chain linkage that closely mimics the anatomical motion of the knee while also supporting loads (Radcliffe, Charles W. “Above-knee prosthetics.” Prosthetics and Orthotics International 1.3 (1977): 146-160; Bapat, Ganesh M., and S. Sujatha. “A method for optimal synthesis of a biomimetic four-bar linkage knee joint for a knee-ankle-foot orthosis.” Journal of Biomimetics, Biomaterials and Biomedical Engineering. Vol. 32. Trans Tech Publications Ltd, 2017). The use of a four-bar linkage in the knee joint is known in the field of orthoses. For example, U.S. Pat. No. 4,940,044 discloses a knee brace specifically adapted for use in athletic applications comprising a pair of frame members disposed on opposite sides of the knee joint which are pivotally connected adjacent one end by way of ratio-swing hinge members in order to mimic knee joint movement.

Another reference can be given as WO 2015/192240, which discloses a passive exoskeleton designed to be worn by a user, is generally configured to support and transfer the load supported by the user down to the ground. The exoskeleton comprises three interconnected sections: a torso section, a hip section, and leg sections, each comprising a plurality of interconnected rigid members which form the load-bearing structure of the exoskeleton. The leg sections of the exoskeleton are designed to ensure that the load-bearing final location is located on the inner side of the feet to promote balance. However, the curved slides in the belt system in the hip section of the exoskeleton is not suitable for use in extreme conditions, such as freezing temperatures. In addition, the use of a sole insert into the footwear of the user can cause discomfort and is not preferable from an ergonomic standpoint.

In order to address the problems in the prior art, the present invention proposes an exoskeleton that utilizes different kinematic joint structures to transfer the load to the ground more efficiently. The exoskeleton of the invention comprises interconnected modules: a hip module configured to be mounted around the hips, leg modules configured to be mounted around the legs, foot modules configured to be mounted around the feet and optionally a back module configured to be mounted to the torso. These modules are connected in such a way to efficiently transfer the load carried by the wearer down to the ground via the hip module, leg modules which are connected to the sides of the hip module, and both sides of the feet via the foot modules. The exoskeleton is configured to be adjustable so that it can be worn by people of varying body types and sizes. In addition, the exoskeleton is easily detachable and individual modules of the exoskeleton can be easily removed.

The exoskeleton of the present invention allows the wearer to carry weights over long distances for a long time with lower effort and preventing musculoskeletal injuries. The exoskeleton is designed mainly for military applications; however, it can be customized for use by climbers, tourists, travelers, rescuers, firefighters, law enforcement officers, and workers in the industrial and logistics sectors, as well as the disabled.

The present invention provides an exoskeleton as described by the characterizing features defined in claim 1.

### Objects of the Present Invention

The object of the invention is to provide an exoskeleton to help load bearing of a wearer while carrying loads, by reducing the discomfort of the user while carrying a load and reducing the load on the joints and increasing the strength and/or endurance of the user.

Another object of the invention is to provide an exoskeleton having improved ergonomics and efficient load distribution while transferring the load normally carried by the wearer down to the ground.

Another object of the invention is to provide an exoskeleton that is form-fitting and configured to be adjustable to the wearer's specific anatomy and/or for a variety of uses.

Another object of the invention is to provide an exoskeleton that can be worn without requiring special footwear, body protection, ballistic plate carriers or backpacks.

Another object of the invention is to provide an exoskeleton that is modular and comprising detachable mechanisms that allow the user to put on and take off the exoskeleton easily.

Another object of the invention is to provide an exoskeleton that operates without the use of any additional sources of energy and propulsion, thereby operating silently and without any need for frequent maintenance.

Another object of the invention is to provide an exoskeleton having potential energy storage elements to absorb energy during certain phases of motion and release this energy to augment/support joint movement during other phases.

### BRIEF DESCRIPTION OF THE TECHNICAL DRAWINGS

Accompanying drawings are given solely for the purpose of exemplifying an exoskeleton, whose advantages over prior art were outlined above and will be explained in brief hereinafter.

The drawings are not meant to delimit the scope of protection as identified in the Claims, nor should they be referred to alone in an effort to interpret the scope identified in said Claims without recourse to the technical disclosure in the description of the present invention.

FIG. 1 demonstrates a perspective view of an exoskeleton with representative footwear.

FIG. 2 demonstrates a perspective view (A), a front view (B) and a side view (C) of an exoskeleton.

FIG. 3 demonstrates a perspective view (A, B) and a top view (C) of the hip module of an exoskeleton.

FIG. 4 demonstrates a close-up view of the hip module of an exoskeleton.

FIG. 5 demonstrates a close-up view of the differently sized hip links of the hip module of an exoskeleton.

FIG. 6 demonstrates a front view (A), perspective view (B) and side view (C) of the leg module as well as the close-up view of different embodiments of the knee flexion/extension connection (D and E) of the leg module of an exoskeleton.

FIG. 7 demonstrates a close-up view of the polycentric knee flexion/extension connections of the leg module of an exoskeleton.

FIG. 8 demonstrates the knee width adjustment means of the leg module of an exoskeleton in closed (A) and extended (B) positions.

FIG. 9 demonstrates the upper leg adjustment means of the hip and leg modules of an exoskeleton in closed (A) and extended (B) positions.

FIG. 10 demonstrates the lower leg adjustment means of the leg and foot modules of an exoskeleton in closed (A) and extended (B) positions.

FIG. 11 demonstrates front (A) and side (B) perspective views of a foot module of an exoskeleton.

FIG. 12 demonstrates a perspective view of a foot module of an exoskeleton.

FIG. 13 demonstrates a release mechanism of a foot module of an exoskeleton.

FIG. 14 demonstrates a perspective view (A) and an exploded view (B) of a back module of an exoskeleton.

FIG. 15 demonstrates a perspective view of a back module of an exoskeleton.

FIG. 16 demonstrates the connection between the back and hip modules of an exoskeleton in attached (A) and unattached (B) positions.

FIG. 17 demonstrates a back view (A), side view (B), perspective view (C) and close-up view (D) of an alternative embodiment of a back module and of an exoskeleton.

FIG. 18 demonstrates a perspective view of the load distribution through the hip, leg, and foot modules of an exoskeleton according to the present invention.

FIG. 19 demonstrates a perspective view of the load distribution through the back, hip, leg, and foot modules of an exoskeleton with representative footwear.

FIG. 20 demonstrates a perspective view (A) and a close-up view (B) of the hip and leg modules of an exoskeleton comprising potential energy storage elements.

FIG. 21 demonstrates a closeup view of the spring-like knee element (A) and spring-like ankle element (B) of an exoskeleton comprising potential energy storage elements. Detailed Description of the Present Invention

The following numerals are referred to in the detailed description of the present invention:

| | |
|---|---|
| 100 | Exoskeleton |
| 200 | Back module |
| 201 | Shoulder member |
| 202 | Back assembly |
| 204 | Height adjustment module |
| 205 | Load carrying member |
| 209 | Back support element |
| 210 | Back straps |
| 211 | Shoulder plate |
| 213 | Hip connection means |
| 214 | Vertebrae element |
| 215 | Vertebrae element connection |
| 300 | Hip module |
| 301 | Hip link |
| 301a | large sized hip link |
| 301b | small sized hip link |
| 302 | Hip link rotation element |
| 303 | Hip rotation link |
| 304 | Hip movement element |
| 307 | Upper leg connection element |
| 308 | Hip link rotation axis |
| 309 | Hip abduction/adduction axis |
| 310 | Hip flexion/extension axis |
| 311 | Upper leg adjustment means |
| 312 | Belt |
| 313 | Lumbar element |
| 314 | Housing |
| 315 | Hip internal/external rotation axis |
| 400 | Leg module |
| 401 | Upper leg member |
| 402 | Lower leg member |
| 403 | Knee section |
| 404 | Upper knee section |
| 405 | Lower knee section |
| 406 | Knee flexion/extension connection |
| 408 | Knee width adjustment means |
| 410 | Lower leg adjustment means |
| 411 | Ankle connection element |
| 500 | Foot module |
| 501 | Ankle fork |
| 502 | Foot support platform |
| 503 | Foot release mechanism |
| 504 | Locking element |
| 505 | Support tab |
| 506 | Ankle dorsi/plantar-flexion axis |
| 507 | Ankle rotation axis |
| 601 | Spring-like knee element |
| 602 | Elastic band |
| 603 | Spring-like ankle element |

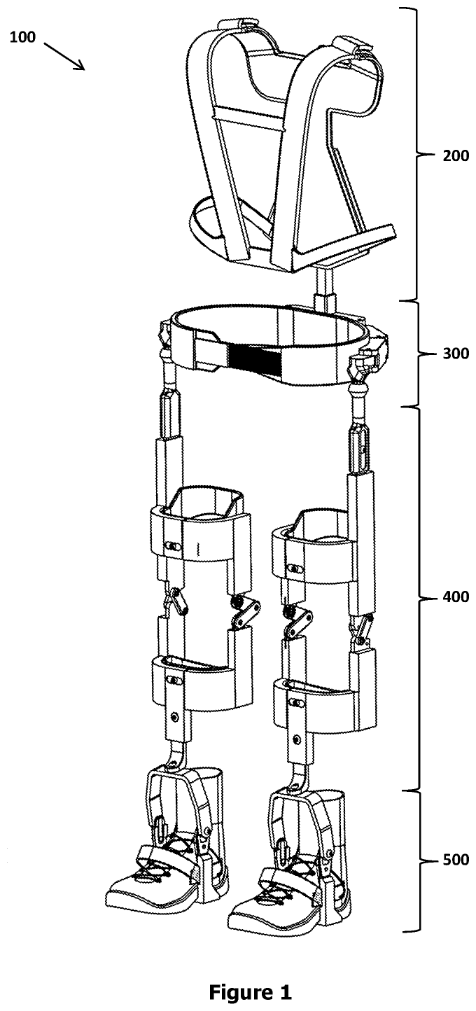

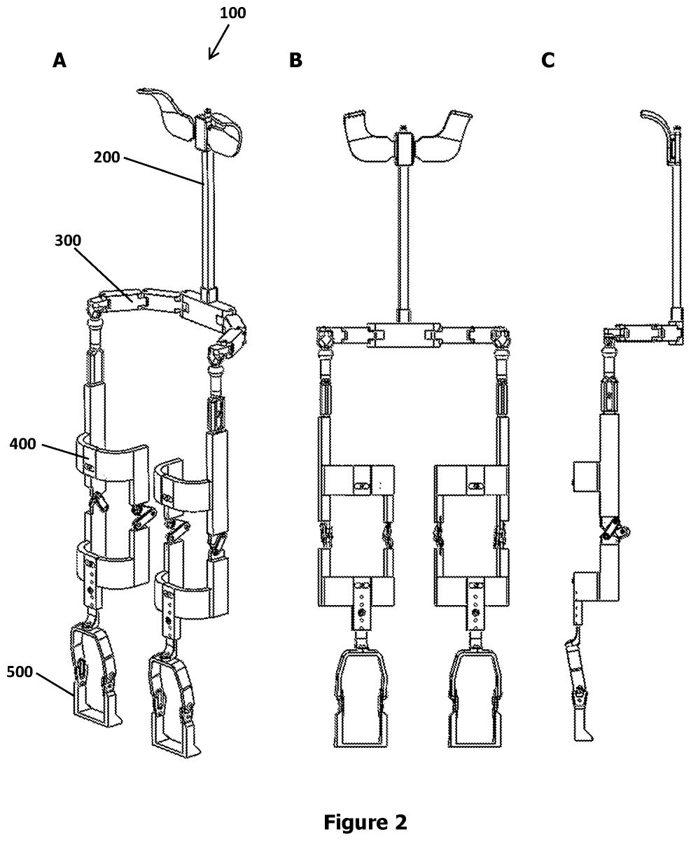

FIGS. 1 and 2 demonstrate an exoskeleton (100) according to an embodiment of the present invention. Said exoskeleton (100) comprises interconnected modules: a back module (200) configured to be mounted to the torso, a hip module (300) configured to be mounted around the hips, leg modules (400) configured to be mounted around the legs, and foot modules (500) configured to be mounted around the feet. These modules are connected in such a way to efficiently transfer the load carried by the wearer down to the ground via the hip module (300), leg modules (400) which are connected to the sides of the hip module (300), and both sides of the feet via the foot modules (500). In a preferred embodiment of the invention said exoskeleton (100) comprises a hip module (300), leg modules (400) and foot modules (500) and optionally a back module (200).

Said back module (200), hip module (300) and leg modules (400) are provided with adjustment mechanisms, such as straps, mechanical fittings, bolts, screws, nuts and/or any other adjustment mechanisms known in the art, in order to provide lateral and longitudinal adjustments on the spine, the hips, the legs and the knees so that said exoskeleton (100) can be worn by people of varying body types and sizes, which will be discussed in detail hereafter.

Structural elements of the exoskeleton (100) are configured to be fixed on the human body using fastening elements, for example, belts with buckles, Velcro strips, ties, and/or any other fastening means known in the art.

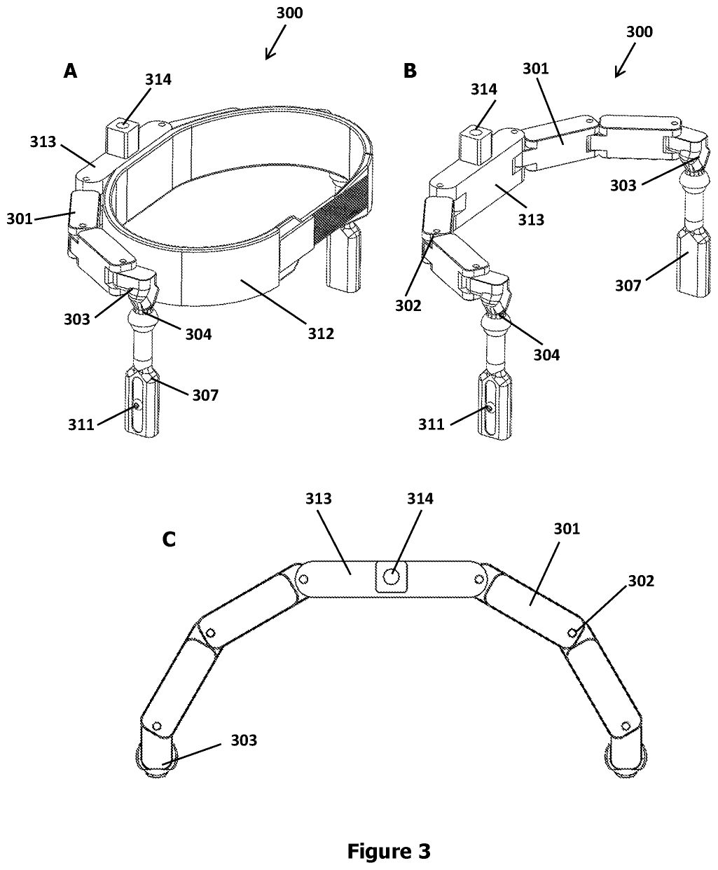

FIGS. 3 and 4 demonstrate the hip module (300) of an exoskeleton (100) according to the present invention. Said hip module (300) is configured to transfer the load to the leg modules (400).

Said hip module (300) comprises a plurality of hip links (301) that are connected to a lumbar element (313) and to each other via hip link rotation elements (302). Said hip module (300) is secured onto the user by a belt (312) that is attached to the lumbar element (313) which circumscribes the waist region of the user. Said hip link rotation elements (302) are preferably in the form of hinge joints having a hip link rotation axis (308) that is parallel to the pelvic rotation of the user in order to bear the load while allowing free torso and pelvis movements of the user. Said hip module (300) further comprises hip rotation links (303) and upper leg connection elements (307) whereby said hip module (300) is connected to said leg modules (400). Said upper leg connection elements (307) comprise upper leg adjustment means (311) in order to adjust the height of the leg module (400) to fit the anatomy of the user.

Said hip rotation links (303) are connected to the hip links (301) via hip link rotation elements (302) described above. Said hip rotation links (303) are connected to said upper leg connection elements (307) via hip movement elements (304). Said hip movement elements (304) provide rotation around a hip abduction/adduction axis (309), thereby allowing the free abduction and adduction movements of the user; a hip flexion/extension axis (310) thereby allowing the free hip flexion and extension movements of the user; and a hip internal/external rotation axis (315) thereby allowing the free internal and external rotation of the hip of the user. Said hip abduction/adduction axis (309), hip flexion/extension axis (310), and hip internal/external rotation axis (315) are parallel to, but not necessarily in perfect alignment with, the actual hip rotation axes of the wearer. The combination of the rotation axes (308, 309, 310, 315) available in hip module (300) allow said hip module (300) to follow and mimic human hip movements whereby ergonomic movements at the hip are achieved. Therefore, in addition to providing sufficient degrees of freedom to allow for pelvic and torso rotations, said hip module (300) also provides three degrees of freedom at each side of the hip joint to allow for free hip movements of the user while bearing the load at the same time.

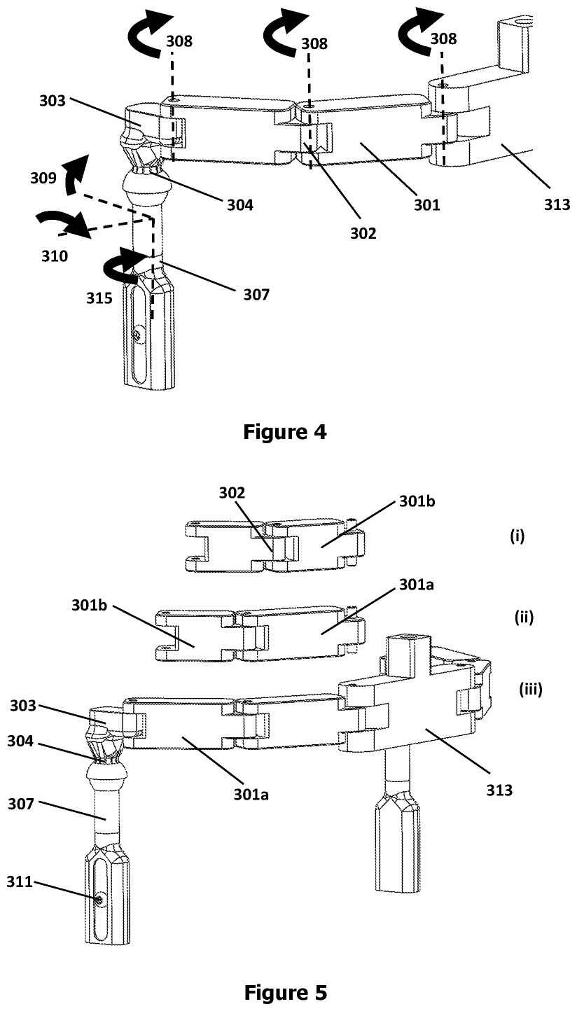

FIG. 5 demonstrates a preferred embodiment of the present invention wherein said hip module (300) comprises two hip links (301) on each side of the user's body. The size of the hip module (300) may be adjusted by using different sized hip links (301a and 301b) in different combinations. For example, the use of two small sized hip links (301b) will result in a small(S) sized hip module (300) (i), the use of one large sized hip link (301a) and one small sized hip link (301b) will result in a medium (M) sized hip module (300) (ii), and the use of two large sized hip links (301a) will result in a large (L) sized hip module (300) (iii). Therefore, the size of the hip module (300) can be conveniently adjusted based on the size of the user. In the present embodiment, said hip module (300) comprises two hip links (301). However, in other embodiments the number of hip links (301) on each side of the user's body may be one or more. In a preferred embodiment, the number of hip links (301) on each side of the user's body may be between one and eight. In a more preferred embodiment, the number of hip links (301) on each side of the user's body may be between two and four. In a most preferred embodiment, the number of hip links (301) on each side of the user's body may be three.

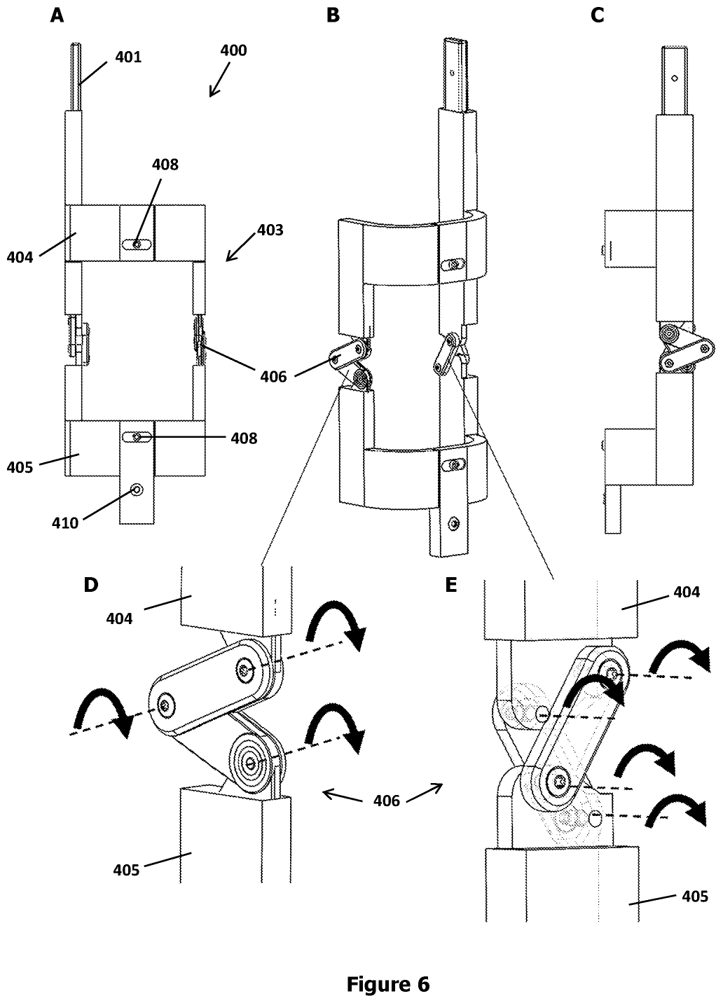

FIGS. 6A-C demonstrate a leg module (400) of an exoskeleton (100) according to the present invention. Hip module (300) is connected to a pair of left and right leg modules (400). In a preferred embodiment, both leg modules (400) are symmetric in that the left leg module is a mirror image of the right leg module. For ease, one leg module (400) will be described below. However, the skilled person can appreciate that it is possible for the right and left leg modules (400) to be asymmetrical.

Said leg module (400) comprises an upper leg member (401) adjustably attached to the upper leg connection elements (307), whereby the leg module (400) is attached to the hip module (300), a knee section (403) and a lower leg member (402). The leg module (400) can be fixed onto the leg of the user via straps, buckles, Velcro strips, ties, and/or any other fastening means known in the art. The length of the upper leg member (401) and the lower leg member (402) can be adjusted via the upper leg adjustment means (311) and lower leg adjustment means (410) respectively in order to fit the anatomy of the user. Said knee section (403) comprises an upper knee section (404), a knee flexion/extension connection (406), a knee width adjustment means (408), and a lower knee section (405).

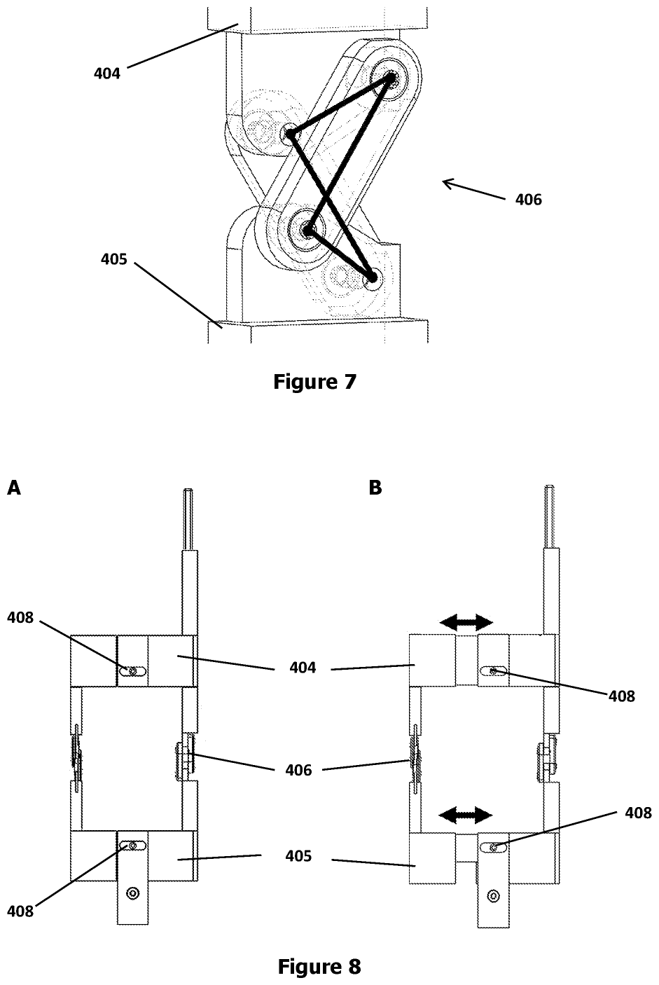

FIGS. 6D-E and 7 demonstrate said knee flexion/extension connection (406) in greater detail. Said knee flexion/extension connections (406) comprise polycentric linkage mechanisms. In a preferred embodiment of the invention shown in FIGS. 6E and 7, at least one of said knee flexion/extension connections (406) comprises a four-bar linkage mechanism, which as described above closely mimics the anatomical motion of the knee allowing the user to perform tasks such as walking, running, or squatting more comfortably for longer periods. In another embodiment of the invention shown in FIG. 6D, at least one of said knee flexion/extension connections (406) comprises a serial two link mechanism. However, the skilled person will appreciate that any other polycentric linkage mechanism available in the art, including but not limited to parallel six-bar linkage mechanisms or double-skid mechanisms, can also be used.

FIG. 8 demonstrates the knee width adjustment means (408) in greater detail. The knee width adjustment means (408) allows the width of the knee section to be adjusted based on the anatomy of the user. In a preferred embodiment, it is possible to adjust the width of the knee and obtain a knee section (403) of sizes S, M, L and XL.

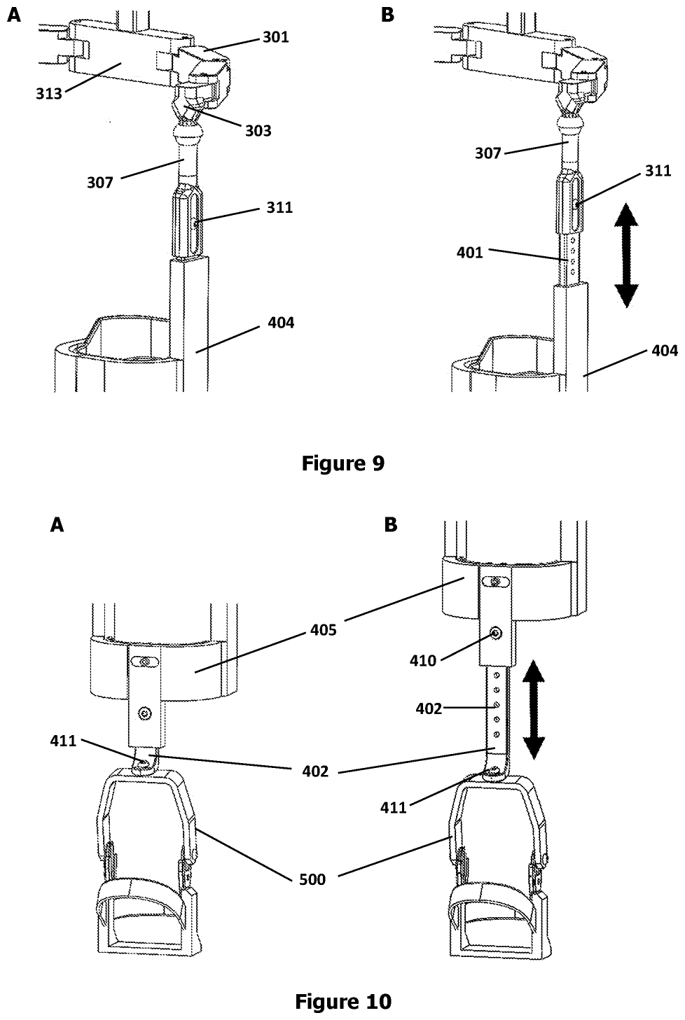

FIG. 9 demonstrates the upper leg adjustment means (311) and FIG. 10 demonstrates the lower leg adjustment means (410) in greater detail in their closed and extended positions. Said lower leg member (402) comprises an ankle connection element (411), whereby the leg module (400) is connected to the foot module (500) and the load is transferred therebetween.

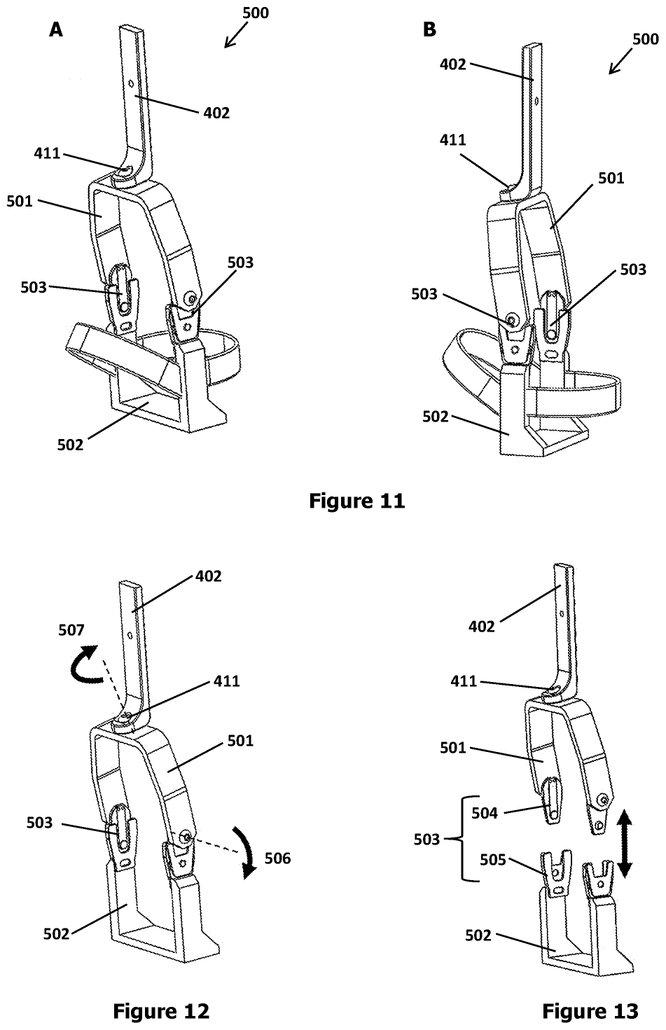

FIGS. 11 and 12 demonstrate a foot module (500) of an exoskeleton (100) according to the present invention. Just as the leg modules (400) described above, in a preferred embodiment, said foot modules (500) are symmetric in that the left foot module is a mirror image of the right foot module. The foot module (500) can be fixed onto the foot of the user via straps, buckles Velcro strips, ties, and/or any other fastening means known in the art. For ease, one foot module (500) will be described below.

Said foot module (500) comprises an ankle fork (501), attached to the ankle connection element (411), whereby the foot module (500) is attached to the leg module (400), and a foot support platform (502). Said foot support platform (502) can be inserted around the footwear of the user, for example, under the sole. Any kind of boots or sneakers with a hard sole can be used as footwear, therefore the exoskeleton (100) does not require special footwear to be used. Said ankle connection element (411) provides a degree of freedom around an ankle rotation axis (507). Said ankle rotation axis (507) is the axis of rotation for a combined inversion/eversion and abduction/adduction motion since the inversion/eversion and abduction/adduction rotations of the ankle take place in a coupled manner.

Said ankle fork (501) and foot support platform (502) are detachably connected by foot release mechanisms (503) positioned on the right and left sides of the footwear of the user. The connection between said ankle fork (501) and said foot support platform (502) provides a degree of freedom around the ankle dorsi/plantar-flexion axis (506) to allow free movement of the feet of the user.

FIG. 13 demonstrates a foot release mechanism (503) in greater detail. Said foot release mechanism (503) comprises a locking element (504) attached to the ankle fork (501), and a support tab (505) attached to the foot support platform (502). While in use, the locking element (504) and the support tab (505) are locked together. If the user requires to unfasten the exoskeleton (100) without removing their footwear or unfastening the upper sections of the exoskeleton (100), they can use a releasing means to quickly detach the foot support platform (502) from the rest of the exoskeleton (100).

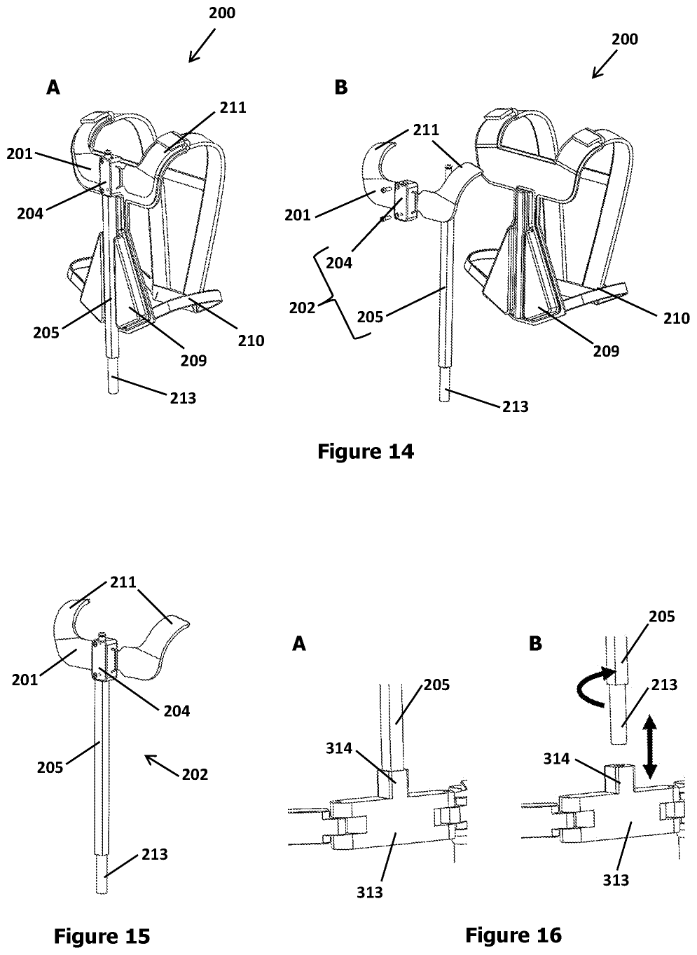

In an alternative embodiment of the invention said exoskeleton (100) further comprises a back module (200) attached onto the hip module (300). FIG. 14 demonstrates the back module (200) of an exoskeleton (100). With additional reference to FIGS. 15 and 16, said back module (200) comprises a shoulder member (201) and a back assembly (202) whereby said back module (200) is connected to the lumbar element (313) of the hip module (300). Back module (200) is configured to be worn by the user via back straps (210).

Said shoulder member (201) comprises at least one shoulder plate (211) configured to take the weight of the load. In a preferred embodiment said shoulder member (201) comprises two shoulder plates (211) corresponding to the wearer's right and left shoulders respectively. In an alternative embodiment, shoulder member (201) may comprise one shoulder plate (211) corresponding to one of the wearer's shoulders, in applications where the load is applied asymmetrically. The load is then transferred from said shoulder member (201) to the back assembly (202) and the lumbar element (313) whereby it is transferred to the hip module (300).

Back assembly (202) comprises a load carrying member (205) and a height adjustment module (204). Said height adjustment module (204) is attached to the shoulder member (201) and is configured to adjust the length of the load carrying member (205) based on the height of the user.

The motions of the legs are coordinated with motions of the spine, shoulders, and arms. Spine, shoulder, and arm motions make walking efficient by reducing braking motions transmitted through the legs and pelvis to the upper body. Energy expenditure in walking is increased if the back is immobilized and rotational motions of the pelvis and shoulders are eliminated (Walsh, Conor J. Biomimetic design of an under-actuated leg exoskeleton for load-carrying augmentation. Massachusetts Inst of Tech Cambridge Media Lab, 2006). In a preferred embodiment of the invention said load carrying member (205) is in the form of a shaft. In a preferred embodiment of the invention said load carrying member (205) is preloaded to counteract the bending loads imposed on the torso of users while carrying any kind of loads placed on shoulder member (201). This provides a preloaded spring effect in said load carrying member (205) to counteract the torque created by the payload. In a more preferred embodiment, said load carrying member (205) is made from flexible material in order to allow more freedom to the user. The flexible load carrying member (205) can bend during walking allowing pelvic obliquity and tilt as well as sideways and forward/backward bending of the torso and can also bear the torque of the load carried by the user.

Said load carrying member (205) comprises a hip connection means (213) that is attachable to a housing (314) of said lumbar element (313), whereby the load carrying member (205) is attached to the lumbar element (313) and the load is transferred from the back assembly (202) to the lumbar element (313). Said hip connection means (213) is designed to be able to slide and rotate inside said housing (314) in order to provide degrees of freedom for the rotation and sideways and forward/backward bending of the torso of the user.

In a preferred embodiment, said back module (200) further comprises a back support element (209) in order to protect the load carrying member (205) and provide the user with extra support. Said back support element (209) may be made out of any type of textile and foam.

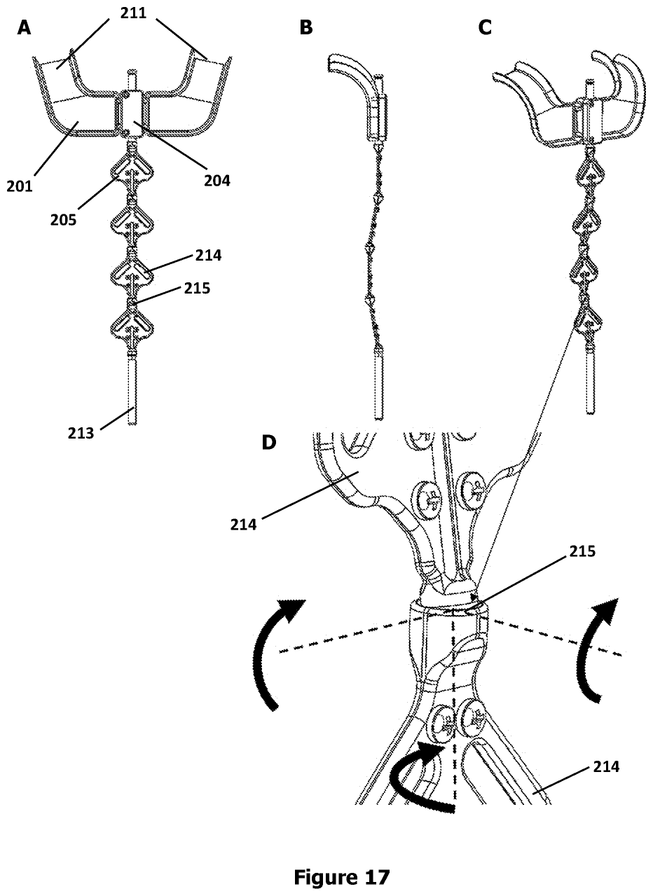

FIG. 17 demonstrates an alternative embodiment of the load carrying member (205). In this embodiment, said load carrying member (205) comprises a plurality of load carrying vertebrae elements (214) attached to each other via vertebrae element connections (215). The vertebrae element connections (215) provide three degrees of freedom around the rotation and sideways and forward/backward bending axes of the torso/spine of the user.

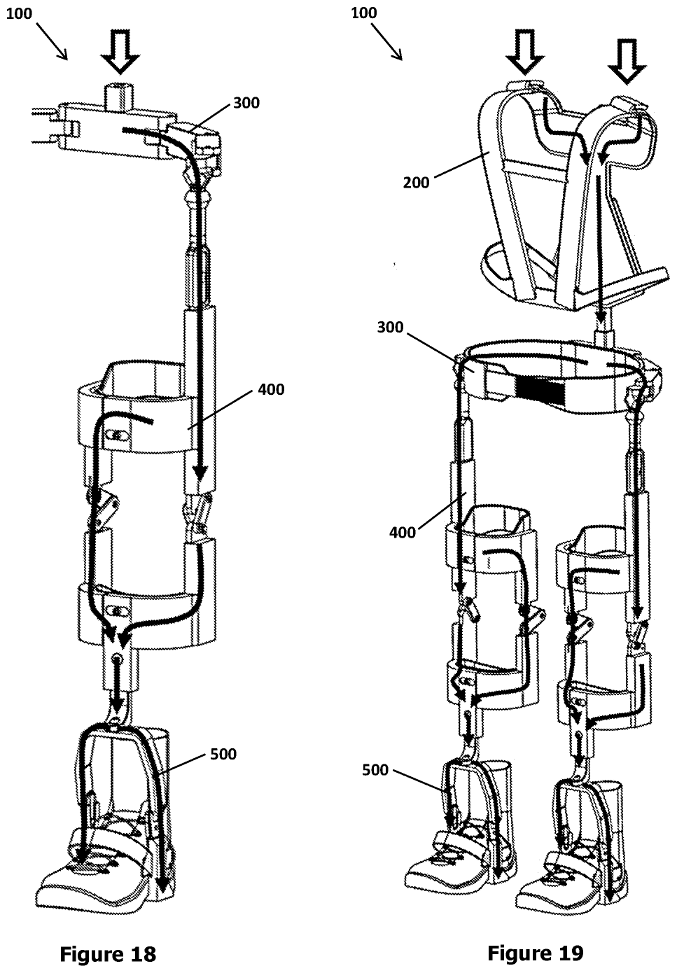

FIG. 18 demonstrates the load transfer along the hip module (300), leg module (400) and foot module (500) of an exoskeleton (100) and FIG. 19 demonstrates the load transfer along the back module (200) hip module (300), leg module (400) and foot module (500) of an exoskeleton (100) according to an alternative embodiment of the invention. As mentioned above, the exoskeleton (100) can be worn by a user to support them to carry loads, and the modular and kinematic structure of the exoskeleton (100) of the present invention allows the load to be transferred to the ground more efficiently.

When a load is applied to the torso (e.g., shoulder, chest and/or back) of the user, the load will be supported by the shoulder member (201) and back assembly (202) of the exoskeleton (100). The load will be transferred down the back assembly (202) to the lumbar element (313). From there, the load will be distributed between the right and left sides of the user via the hip section (300) through the hip links (301), first hip rotation link (303), hip movement element (304) and upper leg connection element (307) whereby it is transferred to the leg modules (400). From there, the load is transferred through the upper leg member (401), the knee section (403) and the lower leg member (402) where the load is directed to the front of the leg. From there, the load is distributed evenly between the right and left sides of the foot via the ankle fork (501) and reaches the foot support platform (502) under the footwear of the user, whereby the load is transferred to the ground.

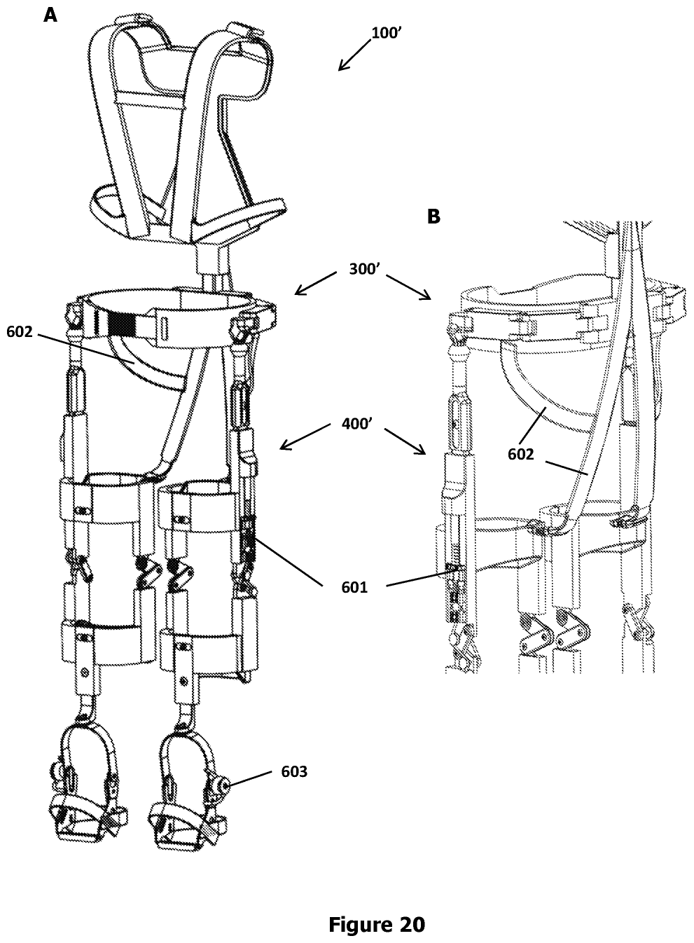

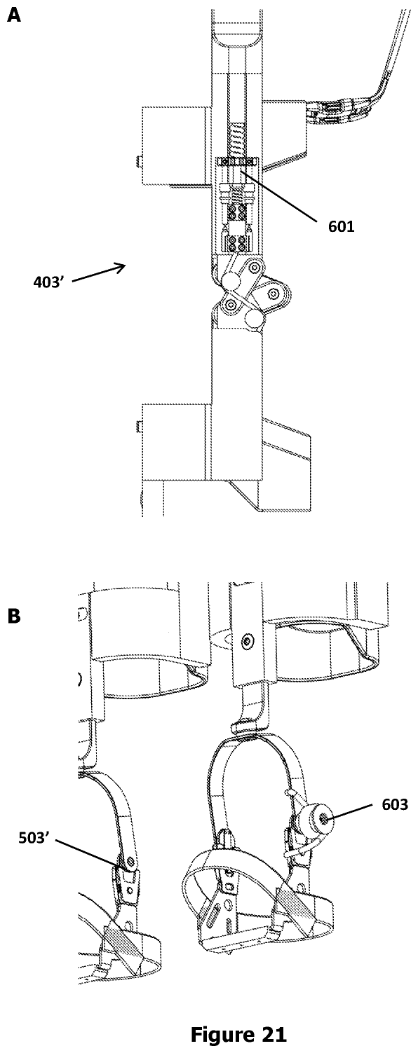

Many muscles responsible for walking contract isometrically to allow for maintenance of upright posture against gravity. Brief bursts of more energy expensive contraction of muscle are added when needed to provide power for forward motion. Positive work is performed when a muscle is concentrically contracting while negative work is said to be performed when a muscle is eccentrically contracting. Much muscle activity in walking is isometric or eccentric. Negative work allows the limbs to absorb energy while resisting the pull of gravity, while positive work of muscles during walking allows acceleration of limbs and powers such activities as flexion of the hip during pre-swing (Walsh, Conor J. Biomimetic design of an under-actuated leg exoskeleton for load-carrying augmentation. Massachusetts Inst of Tech Cambridge Media Lab, 2006). It is possible to incorporate potential energy storage elements into an exoskeleton absorb energy during certain phases of motion and release this energy to augment/support joint movement during other phases. To that end, FIGS. 20 and 21 demonstrate an alternative embodiment of an exoskeleton (100′) comprising potential energy storage elements. Said exoskeleton comprises at least one of spring-like knee elements (601) on at least one knee section (403′), elastic bands (602) connecting the hip module (300′) to the leg modules (400′) and spring-like ankle elements (603) around at least one foot release mechanism (503′). Said spring-like knee elements (601) are configured to provide a resistive torque at the knee on heel strike as energy is absorbed and then release this energy to aid in knee extension during stance. Said elastic bands (602) are configured to exert desired toques to the hip and back. Said spring-like ankle elements (603) to store energy during controlled dorsiflexion and later release this to assist in plantarflexion.

In a preferred embodiment, the exoskeleton (100) is made out of titanium, steel, aluminum, or another lightweight alloy. In addition, the exoskeleton (100) may have some of its components made of composite material, such as carbon fiber, glass fiber, reinforced plastics, polyamides, polyimides and/or combinations thereof.

Users in the military, bomb disposal, firefighting, search and rescue, logistics and material handing etc. may have different needs that need to be addressed. Therefore, it is possible to adjust the modules (200, 300, 400, 500) of the exoskeleton (100) based on the requirements of the application.

In a nutshell, the present invention proposes an exoskeleton (100) configured to be worn by a user in order to support and transfer a load carried by the user comprising a hip module (300) connected to two leg modules (400) each connected to two foot modules (500) respectively, wherein said exoskeleton (100) is adapted to be maintained on the body of the user and follow the user's movements and wherein said exoskeleton (100) is configured in such a way as to transfer to the load carried by the user from the hip module (300) down to the ground via the leg modules (400) and the foot modules (500) when the exoskeleton (100) is in use, and wherein each leg module (400) comprises an upper leg member (401) connected to said hip module (300) and a lower leg member (402) connected to said foot module (500). Each upper leg member (401) and lower leg member (402) are connected by a knee section (403) configured to be fitted around the knee of the user in order to allow the lower leg member (402) to follow the movements of the lower leg of the user with respect to the upper leg. Each knee section (403) comprises knee flexion/extension connections (406) in the form of a polycentric mechanism on at least one of the right and left sides of the user's knee. Each foot module (500) comprises an ankle fork (501) and a foot support platform (502) rotatable and detachably connected by foot release mechanisms (503) wherein said foot release mechanisms (503) are configured to unfasten the exoskeleton (100).

In one variation of the present invention, said hip module (300) comprises a plurality of hip links (301) positioned on each side of the user's body and connected to a lumbar element (313) wherein said hip links (301) are rotatably connected to each other and said lumbar element (313) via hip link rotation elements (302).

In a further variation of the present invention, said hip link rotation elements (302) are in the form of hinge joints having a hip link rotation axis (308) that is parallel to the pelvic rotation axis of the user in order to bear the load while allowing free torso and pelvis movement to the user.

In a further variation of the present invention, the number of hip links (301) on each side of the user's body is between one and eight. In a further variation of the present invention, the number of hip links (301) on each side of the user's body is three.

In a further variation of the present invention, said hip links (301) are large sized hip links (301a), small sized hip links (301b) or a combination of both wherein the number of large sized hip links (301a) and small sized hip links (301b) are changeable in order to adjust the size of the hip module (300) based on the size of the user.

In a further variation of the present invention, said hip module (300) further comprises hip rotation links (303) connected to said hip links (301) and upper leg connection elements (307) whereby said hip module (300) is connected to said leg modules (400) wherein positioned on each side of the user's body, wherein said hip rotation links (303) and upper leg connection elements (307) are connected via hip movement elements (304) and wherein said hip movement elements (304) are configured to provide rotation around the hip abduction/adduction axis (309), hip flexion/extension axis (310) and hip internal/external rotation axis (315), which are parallel to said hip rotation axes of the user.

In a further variation of the present invention, at least one of the polycentric mechanisms of the knee flexion/extension connections (406) is a four-bar linkage mechanism.

In a further variation of the present invention, each knee section (403) comprises knee width adjustment means (408) configured to adjust the size of said knee section (403).

In a further variation of the present invention, the upper leg member (401) is configured to have a height that is adjustable by an upper leg adjustment means (311) of said hip module (300).

In a further variation of the present invention, the lower leg member (402) is configured to have a height that is adjustable by a lower leg adjustment means (410) of said leg module (400).

In a further variation of the present invention, said leg module (400) comprises an ankle connection element (411) attached to said lower leg member (402) whereby said leg module (400) is connected to said ankle fork (501) of said foot module (500) and wherein said ankle connection element (411) provides a degree of freedom around an ankle rotation axis (507).

In a further variation of the present invention, the connection between said ankle fork (501) and said foot support platform (502) is configured to be rotatable around an ankle dorsi/plantar-flexion axis (506).

In a further variation of the present invention, said foot release mechanism (503) comprises a locking element (504) attached to said ankle fork (501), and a support tab (505) attached to said foot support platform (502), wherein said locking element (504) and said support tab (505) are locked together while in use and wherein foot release mechanism (503) further comprises a releasing means configured to be unfastened in order to detach the foot support platform (502) from the rest of the exoskeleton (100).

In a further variation of the present invention, said foot support platform (502) is configured to be inserted around the footwear of the user whereby said exoskeleton is configured to be used by any footwear.

In a further variation of the present invention, said exoskeleton (100) comprises a back module (200) connected to said hip module (300). In a further variation of the present invention, said back module (200) comprises a shoulder member (201) configured to be fitted onto the shoulder of the user, connected to a back assembly (202), wherein said back assembly (202) comprises a load carrying member (205) and a height adjustment module (204) configured to adjust the length of the load carrying member (205) based on the height of the user.

In a further variation of the present invention, said load carrying member (205) comprises a hip connection means (213) configured to be rotatably and slidably attached to a housing (314) of a lumbar element (313) of said hip module (300).

In a further variation of the present invention, said load carrying member (205) is preloaded to counter act bending loads imposed on the torso of users while carrying any kind of loads placed on shoulder member (201).

In a further variation of the present invention, said exoskeleton (100) comprises at least one potential energy storage element in at least one joint area of said exoskeleton (100) configured to store energy during certain phases of motion and release said energy to augment or support joint movement during other phases of motion.

In a further variation of the present invention, said exoskeleton (100) further comprises straps and belts (312) adaptable to a size of the user's torso, legs, foot, and waist respectively for securing said exoskeleton (100) to the user's body.

1. An exoskeleton configured to be worn by a user in order to support and transfer a load carried by the user comprising a hip module connected to two leg modules each connected to two foot modules respectively, wherein said exoskeleton is adapted to be maintained on the body of the user and follow the user's movements and wherein said exoskeleton is configured in such a way as to transfer to the load carried by the user from the hip module down to the ground via the leg modules and the foot modules when the exoskeleton is in use, and wherein each leg module comprises an upper leg member connected to said hip module and a lower leg member connected to said foot module, wherein:
each upper leg member and lower leg member are connected by a knee section configured to be fitted around the knee of the user in order to allow the lower leg member to follow the movements of the lower leg of the user with respect to the upper leg,
each knee section comprises knee flexion/extension connections in the form of a polycentric mechanism on at least one of the right and left sides of the user's knee, and
each foot module comprises an ankle fork and a foot support platform rotatable and detachably connected by foot release mechanisms wherein said foot release mechanisms are configured to unfasten the exoskeleton.

2. An exoskeleton as set forth in claim 1, wherein said hip module comprises a plurality of hip links positioned on each side of the user's body and connected to a lumbar element, wherein each of said plurality of hip links are is rotatably connected to an adjacent hip link and/or said lumbar element via hip link rotation elements.

3. An exoskeleton as set forth in claim 2, wherein said hip link rotation elements are in the form of hinge joints having a hip link rotation axis that is parallel to the pelvic rotation axis of the user in order to bear the load while allowing free torso and pelvis movement to the user.

4. An exoskeleton as set forth in claim 2, wherein the number of hip links on each side of the user's body is between one and eight.

5. An exoskeleton as set forth in claim 4, wherein the number of hip links on each side of the user's body is three.

6. An exoskeleton as set forth in claim 2, wherein said hip links comprise large sized hip links, small sized hip links or a combination of both, wherein a number of large sized hip links and small sized hip links are changeable in order to adjust the size of the hip module based on the size of the user.

7. An exoskeleton as set forth in claim 2, wherein said hip module further comprises hip rotation links connected to said hip links and upper leg connection elements whereby said hip module is connected to said leg modules positioned on each side of the user's body, wherein said hip rotation links and upper leg connection elements are connected via hip movement elements and wherein said hip movement elements are configured to provide rotation around a hip abduction/adduction axis, a hip flexion/extension axis and a hip internal/external rotation axis, which are parallel to hip rotation axes of the user.

8. An exoskeleton as set forth in claim 1, wherein at least one of the polycentric mechanisms of the knee flexion/extension connections is a four-bar linkage mechanism.

9. An exoskeleton as set forth in claim 1, wherein each knee section comprises a knee width adjustment means configured to adjust the size of said knee section.

10. An exoskeleton as set forth in claim 1, wherein the upper leg member is configured to have a height that is adjustable by an upper leg adjustment means of said hip module.

11. An exoskeleton as set forth in claim 1, wherein the lower leg member is configured to have a height that is adjustable by a lower leg adjustment means of said leg module.

12. An exoskeleton as set forth in claim 1, wherein said leg module comprises an ankle connection element attached to said lower leg member whereby said leg module is connected to said ankle fork of said foot module and wherein said ankle connection element provides a degree of freedom around an ankle rotation axis.

13. An exoskeleton as set forth in claim 1, wherein the connection between said ankle fork and said foot support platform is configured to be rotatable around an ankle dorsi/plantar-flexion axis.

14. An exoskeleton as set forth in claim 1, wherein said foot release mechanism comprises a locking element attached to said ankle fork, and a support tab attached to said foot support platform, wherein said locking element and said support tab are locked together while in use, and wherein foot release mechanism further comprises a releasing means configured to be unfastened in order to detach the foot support platform from the rest of the exoskeleton.

15. An exoskeleton as set forth in claim 1, wherein said foot support platform is configured to be inserted around the footwear of the user whereby said exoskeleton is configured to be used with any footwear.

16. An exoskeleton as set forth in claim 1, wherein said exoskeleton comprises a back module connected to said hip module.

17. An exoskeleton as set forth in claim 16, wherein said back module comprises a shoulder member configured to be fitted onto a shoulder of the user, connected to a back assembly, wherein said back assembly comprises a load carrying member and a height adjustment module configured to adjust the length of the load carrying member based on the height of the user.

18. An exoskeleton as set forth in claim 17, wherein said load carrying member comprises a hip connection means configured to be rotatably and slidably attached to a housing of a lumbar element of said hip module.

19. An exoskeleton as set forth in claim 17, wherein said load carrying member is preloaded to counter act bending loads imposed on the torso of users while carrying any kind of loads placed on shoulder member.

20. An exoskeleton as set forth in claim 1, wherein said exoskeleton comprises at least one potential energy storage element in at least one joint area of said exoskeleton configured to store energy during certain phases of motion and release said stored energy to augment or support joint movement during other phases of motion.

21. (canceled)
